(19) United States
(12) Patent Application Publication
(10) Pub. No.: US 2020/0351265 A1
(43) Pub. Date: Nov. 5, 2020

(54) SECURE DASHBOARD USER INTERFACE FOR MULTI-ENDPOINT MEETING

(71) Applicant: Cisco Technology, Inc., San Jose, CA (US)

(72) Inventors: Uday Srinath, Redmond, WA (US); Alan Gatzke, Bainbridge Island, WA (US); Murray Mar, Bellevue, WA (US); Kian Shahla, Bellevue, WA (US)

(73) Assignee: Cisco Technology, Inc., San Jose, CA (US)

(21) Appl. No.: 16/401,731

(22) Filed: May 2, 2019

(51) Int. Cl. H04L 29/06; H04L 12/18; H04N 7/15

(52) U.S. Cl. CPC H04L 63/0861; H04L 12/1818; H04N 7/152; H04N 7/155; H04L 12/1822

(57) ABSTRACT

A secure dashboard user interface for a multi-endpoint meeting may be provided. First, a schedule and meeting information for a meeting hosted by a video conferencing service may be retrieved. The schedule may be provided for display through a dashboard user interface of a shared device located within or proximate to a conference room reserved for the meeting. Next, a presence of a user may be detected at an endpoint of the video conferencing service, and an identity of the user may be determined. Based on the identity of the user, a determination of whether to display the meeting information may be made. In response to a determination to display, one or more portions of the meeting information may be provided for display through the dashboard user interface of the shared device.

### TECHNICAL FIELD

The present disclosure relates generally to the secure display of meeting information.

### BACKGROUND

Multi-endpoint conferencing systems allow participants located in multiple different locations to collaborate in a meeting. For example, some participants may be physically present in a conference room reserved for the meeting and join the meeting via a local endpoint of the conferencing system, while other participants may remotely join the meeting via one or more remote endpoints of the conferencing system. These collaborative meetings are often scheduled in advance, and associated meeting information may be displayed openly along with a list of the meetings scheduled for the conference room on a display internal and/or external to the conference room. However, sometimes the meeting information may be confidential or include sensitive information that the meeting organizer or participants would prefer not be displayed to non-participants. Thus, there is a need to effectively secure meetings from information leaks, while also enabling those organizing and participating in the meeting to have access to the meeting information.

### BRIEF DESCRIPTION OF THE FIGURES

The accompanying drawings, which are incorporated in and constitute a part of this disclosure, illustrate various embodiments of the present disclosure. In the drawings:

FIG. 1 shows an operating environment for providing a secure dashboard user interface for a multi-endpoint meeting;

FIG. 2 is a flow chart of a method for providing a secure dashboard user interface for a multi-endpoint meeting;

FIG. 3 is an example configuration of a dashboard user interface of a shared device displayed prior to user detection at one or more endpoints;

FIG. 4 is an example configuration of a dashboard user interface of a shared device displayed subsequent to a single user detection at a local endpoint;

FIG. 5 is an example configuration of a dashboard user interface displayed subsequent to multiple user detection at a local endpoint and one or more remote endpoints;

FIG. 6 is an example notification displayed on a personal device of an authorized user at a local endpoint;

FIG. 7 is an example notification displayed on a personal device of an authorized user at a remote endpoint;

FIG. 8 is another example notification displayed on a personal device of an authorized user at a remote endpoint; and

FIG. 9 is a block diagram of a computing device.

### DETAILED DESCRIPTION

### Overview

A secure dashboard user interface for a multi-endpoint meeting may be provided. First, a schedule and meeting information for a meeting hosted by a video conferencing service may be retrieved. The schedule may be provided for display through a dashboard user interface of a shared device located within or proximate to a conference room reserved for the meeting. Next, a presence of a user may be detected at an endpoint of the video conferencing service, and an identity of the user may be determined. Based on the identity of the user, a determination of whether to display the meeting information may be made. In response to a determination to display, one or more portions of the meeting information may be provided for display through the dashboard user interface of the shared device.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Multi-endpoint conferencing systems allow participants located in multiple different locations to collaborate in a meeting. These collaborative meetings are often scheduled in advance and a physical conference room associated with a local endpoint of the video conferencing system may be reserved for the meeting, even though some or all of the participants may be joining the meeting remotely via one or more remote endpoints. Several meetings may be scheduled for the conference room on a given day, week, or month. Meeting information, such as a subject, a description, an organizer, participants, and associated documents, may often be visually displayed along with a list of the meetings scheduled for the conference room through a shared device. The shared device may be located within and/or proximate to the conference room. For example, the shared device may be a conferencing device within the conference room or a display device located external but proximate to the conference room (e.g., a display device mounted on an exterior wall of the conference room). While the display of meeting information may be very useful to the organizer and participants of the meeting, for some meetings, the meeting information may be confidential and/or include sensitive information that the meeting organizer or participants would prefer not be displayed openly to any person stopping into or passing by the conference room.

Embodiments of the disclosure provide a way to achieve a balance between providing useful meeting information to authorized users, and otherwise suppressing the display of the meeting information to enhance meeting security. For example, facial recognition technology and/or proximity technology may be leveraged in conjunction with a collaboration system hosting calendaring and video conferencing services to determine an identity of a user and display one or more portions of meeting information through the shared device based on the identity of the user.

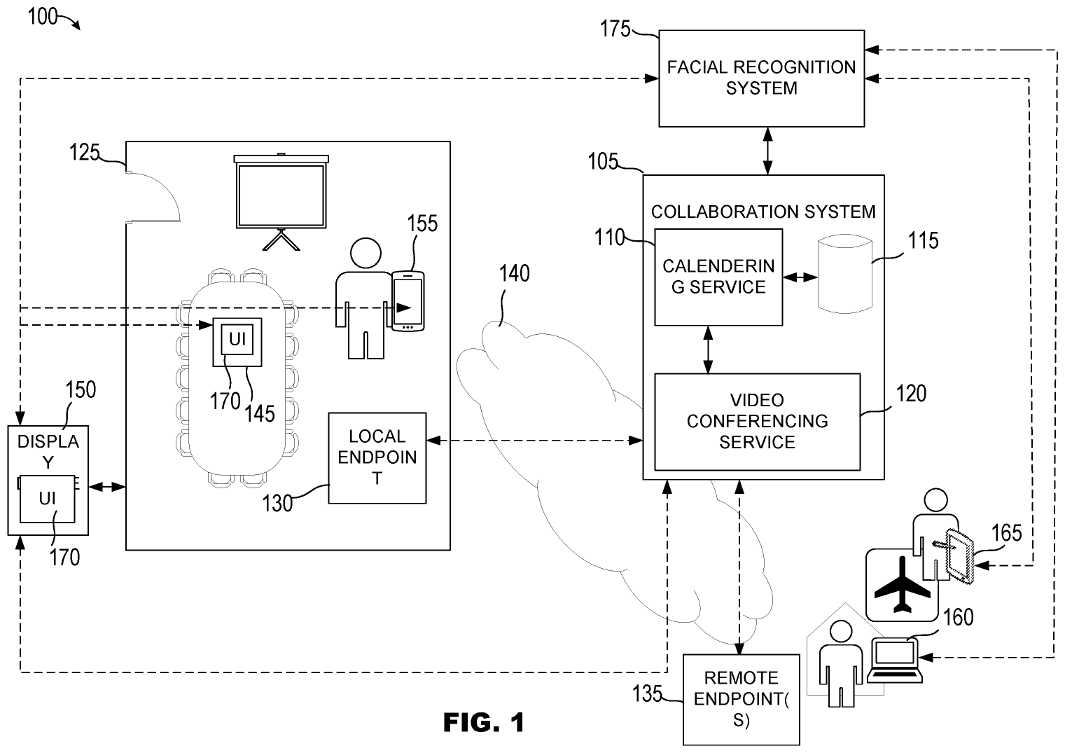

FIG. 1 shows an operating environment 100 for providing a secure dashboard user interface for a multi-endpoint meeting. As shown in FIG. 1, operating environment 100 may comprise a collaboration system 105. Collaboration system 105 may include at least a calendaring service 110, a database 115, and a video conferencing service 120.

An organizer may use calendaring service 110 to schedule a meeting. To schedule the meeting, the organizer may be prompted to select a date and time block, as well as input various types of meeting information, such as a subject, a location (e.g., a conference room 125), a description, one or more participants, and any associated documents. The meeting schedule may be stored within database 115 along with the meeting information.

In some embodiments, the meeting may be a multi-endpoint meeting to be hosted by video conferencing service 120. For example, video conferencing service 120 may host the meeting between a local endpoint 130 associated with conference room 125 and one or more remote endpoints 135 over a network 140. Communication data associated with the meeting may originate from local endpoint 130, and video conferencing service 120 may facilitate exchange of communication data between local endpoint 130 and remote endpoints 135. Video conferencing service 120 may be communicatively coupled with calendaring service 110, and retrieve the meeting schedule and information from calendaring service 110 and/or database 115.

Local endpoint 130 may include one or more endpoint devices located within and/or proximate to conference room 125, where conference room 125 may be a physical room in an office building, for example. Remote endpoints 135 may include one or more endpoint devices located geographically separate from conference room 125. The endpoint devices at either local endpoint 130 or remote endpoint 135 may be any device in communication with video conferencing service 120, such as mobile phones, laptops, desktops, tablets, conferencing devices, etc. As illustrated in operating environment 100, the endpoint devices of local endpoint 130 may include a conferencing device 145 installed in conference room 125, a display device 150 mounted on an exterior wall of conference room 125, and a mobile phone 155 of a user physically present in conference room 125. Endpoint devices of remote endpoints 135 may include a laptop 160 of a user who is connecting with video conferencing service 120 remotely from a home office, and a tablet 165 of a user who is connecting with video conferencing service 120 remotely from an airport while on travel.

Conference room 125 may be a physical room where one or more meetings, including the multi-endpoint meeting, are scheduled to take place. Local endpoint 130 of video conferencing service 120 may be associated with conference room 125. As previously discussed, communication data associated with the meeting may originate from local endpoint 130, and video conferencing service 120 may facilitate exchange of communication data between local endpoint 130 and remote endpoints 135.

Conference room 125 may include one or more shared devices that are accessible by multiple different users, such as conferencing device 145 and display device 150. For example, any user that is physically present in conference room 125 may have access to conferencing device 145 and information displayed thereon. Similarly, any user walking past conference room 125 may view information displayed through display device 150. Additionally, in some embodiments, endpoint devices of both local endpoint 130 and remote endpoints 135 that are personal to a user (e.g., mobile phone 155, laptop 160, and tablet 165) may be paired with conferencing device 145. As a result, information displayed through conferencing device 145 may also be viewable on a paired endpoint device.

Conferencing device 145 and display device 150 may be communicatively coupled to collaboration system 105, and may each include a dashboard user interface 170. Dashboard user interface 170 may display a list of meetings scheduled in conference room 125 over a particular time period (e.g., over a day, a week, or a month). The list may include a schedule for each meeting. For example, the schedule may be a time block for each meeting. Dashboard user interface 170 may also display one or more portions of meeting information for each meeting within the list. The schedule of meetings and the one or more portions of meeting information displayed within the list through dashboard user interface 170 may be received from collaboration system 105. In additional examples, dashboard user interface 170 may display options to join the meeting, edit the meeting, and/or schedule a new meeting.

Facial recognition system 175 may enhance a security of dashboard user interface 170 by allowing biometric authentication to control the one or more portions of meeting information displayed through dashboard user interface 170. In some examples, facial recognition system 175 may be an integral component of collaboration system 105. In other examples, facial recognition system 175 may be a separate system communicatively coupled to collaboration system 105.

Facial recognition system 175 may receive images or live video captured by a camera or other similar recording device of the endpoint devices of local endpoint 130 or remote endpoints 135 (e.g., conferencing device 145, display device 150, mobile phone 155, laptop 160, or tablet 165). In some examples, the camera capturing the images or live video may be a depth sensing camera. Facial recognition system 175 may detect a face in the received images or video, quantify features of the face, and then match the quantified features against templates to identify the user. In some embodiments, the templates may be created based on contact information retrieved from collaboration system 105. In some embodiments, facial recognition system 175 may implement deep learning facial recognition. Factors such as lighting, facial features, contours, pose, and noise may be measured and analyzed to increase an accuracy of the identification. In other embodiments, the user may be identified via other techniques for biometric authentication, such as fingerprint, iris or hand scanning or behavioral based authentication through keystroke, signature or voice analysis, among other similar examples.

In other embodiments, proximity technology may be employed instead of or in addition to facial recognition system 175 to determine an identity of the user. Particularly, the proximity technology may be used to determine the identity of users physically present in or near conference room 125. For example, a proximity service associated with video conferencing service 120 may be enabled on local endpoint 130. When enabled, an inaudible ultrasonic sound token may be generated and output via an audio output device (e.g., via speakers) of one or more of the conferencing device 145 and display device 150. The token may be sent within an encoded message that includes an Internet Protocol (IP) address of the conferencing device 145 and/or display device 150.

Other endpoint devices at local endpoint 130, such as mobile phone 155, may be executing an application associated with the proximity service, and may record the message through an input device (e.g., a microphone). The token and IP address may be extracted from the message, where the token may include information associated with connecting to video conferencing service 120 over network 140. For example, mobile phone 155 may establish a connection to video conferencing service 120 by transmitting the token to the IP address of conferencing device 145 and/or display device 150 in conference room 125 for authentication of the token and subsequent authorization of mobile phone 155. Each endpoint device may be associated with a known user. Therefore, the connection of the endpoint device may enable determination of the identity of the user as the known user associated with the endpoint device. For example, the connection of mobile phone 155 may lead to a determination that the identity of the user physically present in conference room 125 is the known user associated with mobile phone 155.

Once a user is identified by facial recognition system 175 and/or by employing proximity technology, collaboration system 105 may determine for each meeting within the list, which, if any, of the one or more portions of the meeting information to display based on the user's identity. For example, collaboration system 105 may determine whether the identified user is authorized to access the one or more portions of the meeting information. The determined portions may be displayed along with the respective schedule of meetings through dashboard user interface 170 of conferencing device 145 and/or display device 150.

In some embodiments, collaboration system 105 may also implement voice interactivity to audibly present the determined portions of meeting information to an authorized user. For example, collaboration system 105 may include a voice interaction system component or may be communicatively coupled to a separate voice interaction system. The voice interaction system may generate audio output comprising the determined portions of meeting information for aural presentation to the user via an audio output device of one or more of conferencing device 145, display device 150, or other endpoint device personal to the user. In some examples, a speech recognition language may be pre-selected for use in the voice interactions based on the identification of the user via facial recognition. Additionally, voice interactions may be switched from a speaker independent to a more accurate speaker dependent mode once the user has been identified.

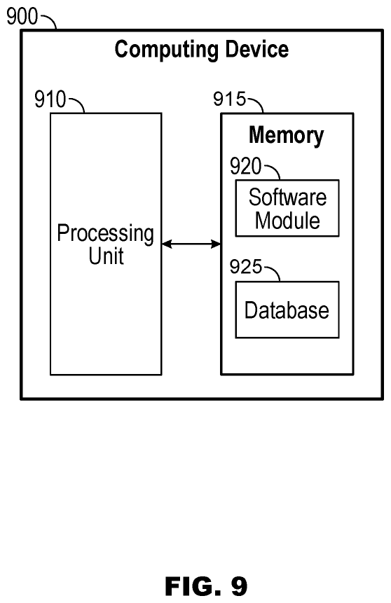

The elements described above of operating environment 100 (e.g., collaboration system 105, calendaring service 110, database 115, video conferencing service 120, local endpoint 130, remote endpoints 135, network 140, shared endpoint devices including conferencing device 145 and display device 150, other endpoint devices including mobile phone 155, laptop 160, and tablet 165, dashboard user interface 170, and facial recognition system 175) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 9, the elements of operating environment 100 may be practiced in a computing device 900.

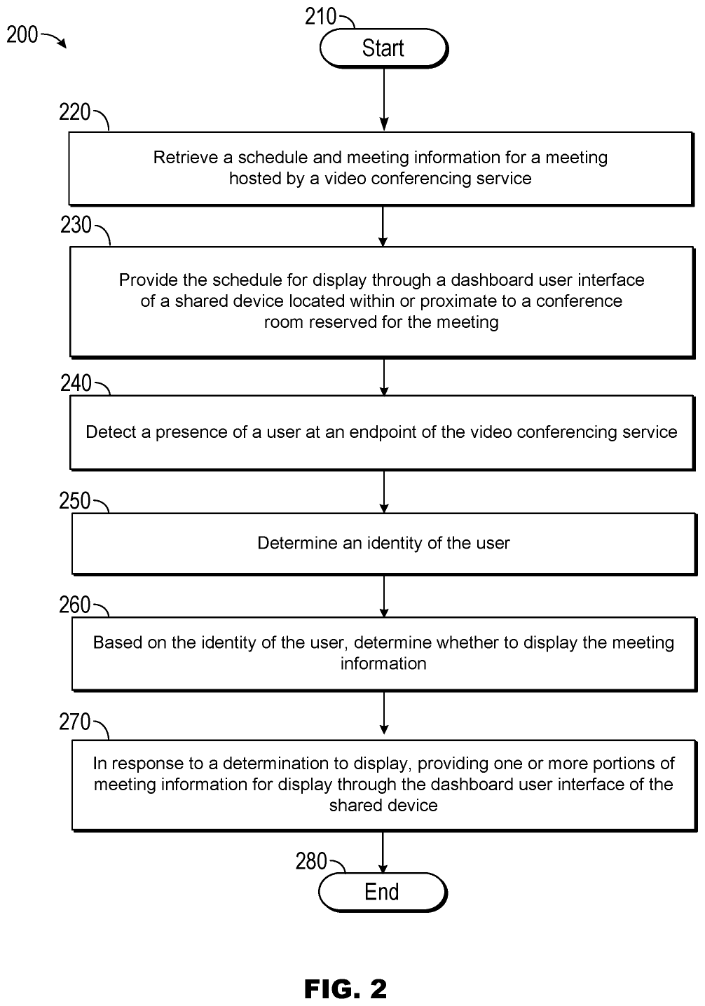

FIG. 2 is a flow chart setting forth the general stages involved in a method 200 consistent with embodiments of the disclosure for providing a secure dashboard user interface for a multi-endpoint meeting. Method 200 may be implemented using collaboration system 105 that leverages facial recognition technology of facial recognition system 175 to control meeting information displayed through dashboard user interface 170. As described in FIG. 1, facial recognition system 175 may be an integral component of collaboration system 105 or may be a separate system communicatively coupled to collaboration system 105. Ways to implement the stages of method 200 will be described in greater detail below.

Method 200 may begin at starting block 210 and proceed to stage 220 where a schedule and meeting information for a meeting hosted by video conferencing service 120 may be retrieved. The schedule and meeting information may be retrieved from calendaring service 110 and/or database 115. In some embodiments, the meeting may be a multi-endpoint meeting. For example, video conferencing service 120 may host the meeting between local endpoint 130 and one or more remote endpoints 135 over network 140.

Once the schedule and the meeting information are retrieved at stage 220, method 200 may proceed to stage 230 where the schedule for the meeting may be displayed through dashboard user interface 170 of a shared device located within or proximate to conference room 125 reserved for the meeting. Conference room 125 may be a physical location or room in which the meeting was scheduled to be held. In one example, the shared device may be conferencing device 145 located within conference room 125. In another example, shared device may be display device 150 located external but proximate to conference room 125, such as on an exterior wall of conference room. The shared device may connect to video conferencing service 120 via local endpoint 130.

The schedule displayed may be a time block of the meeting indicating a start and end time of the meeting, for example. Initially only the schedule may be displayed, and the meeting information (e.g., a subject, a description, and organizer, participants, and associated documents, among other information) may be suppressed, hidden, or otherwise blocked from display through dashboard user interface 170 of the shared device.

From stage 230, where the schedule for the meeting is displayed through dashboard user interface 170 of the shared device, method 200 may advance to stage 240 where a presence of a user may be detected at an endpoint of video conferencing service 120. The endpoint at which the user's presence is detected may be local endpoint 130 or one of remote endpoints 135. For example, if a user is physically present within or is proximate to conference room 125, the user's presence may be detected at local endpoint 130 via conferencing device 145, display device 150, and/or another endpoint device (e.g., mobile phone 155). If a user is physically present in a location geographically separate from conference room 125, the user's presence may be detected at one of remote endpoints 135 via an endpoint device (e.g., laptop 160 or tablet 165).

Once the user's presence has been detected in stage 240, method 200 may continue to stage 250 where an identity of the user may be determined. In some embodiments, the identity of the user may be determined by performing facial recognition. For example, facial recognition system 175 may receive an image or a video captured by an endpoint device at local endpoint 130 or one of remote endpoints 135 of video conferencing service 120. For example, if the user is physically present within or proximate to conference room, a camera of the shared device (e.g., camera of conferencing device 145 and/or display device 150) or a camera of another endpoint device (e.g., mobile phone 155) may capture the image or video. If the user is physically present in a geographic location separate from conference room 125, a camera of an endpoint device of one or more remote endpoints 135 (e.g., laptop 160 or tablet 165) may capture the image or video.

Facial recognition system 175 may detect a face in the received image or video, quantify features of the face, and then match the features against templates to determine an identity of the user. In some embodiments, the templates may be created based on contact information retrieved from collaboration system 105. For example, collaboration system 105 may be associated with an entity, such as a corporation, and contact information retrieved from collaboration system 105 may include employees of the corporation.

In other embodiments, the identity of the user may be determined by employing proximity technology. Particularly, the proximity technology may be used to determine the identity of users physically present in or near conference room 125. For example, a proximity service associated with video conferencing service 120 may be enabled on local endpoint 130. When enabled, an inaudible ultrasonic sound token may be generated and output via an audio output device (e.g., via speakers) of one or more of the conferencing device 145 and display device 150. The token may be sent within an encoded message that includes an Internet Protocol (IP) address of the conferencing device 145 and/or display device 150.

Other endpoint devices at local endpoint 130, such as mobile phone 155, may be executing an application associated with the proximity service, and may record the message through an input device (e.g., a microphone). The token and IP address may be extracted from the message, where the token may include information associated with connecting to video conferencing service 120 over network 140. For example, mobile phone 155 may establish a connection to video conferencing service 120 by transmitting the token to the IP address of conferencing device 145 and/or display device 150 in conference room 125 for authentication of the token and subsequent authorization of mobile phone 155. Each endpoint device may be associated with a known user. Therefore, the connection of the endpoint device may enable determination of the identity of the user as the user associated with the endpoint device. For example, the connection of mobile phone 155 may lead to a determination that the identity of the user physically present in conference room 125 is the known user associated with mobile phone 155.

In further embodiments, the identity of the user may be determined based on a combination of facial recognition and proximity-based techniques.

Once the user's identity is determined at stage 250, method 200 may proceed to stage 260, where collaboration system 105 determines whether to display the meeting information based on the identity of the user. For example, collaboration system 105 may determine whether the user is authorized to access the meeting information. An authorized user may be an organizer of the meeting, a participant of the meeting, or a user that has been designated a role, status or permissions that allow the user access to the meeting information, among other examples.

Collaboration system 105 may determine whether the identified user is an organizer or participant of the meeting by comparing an identity of the user to the meeting information for the meeting retrieved from calendaring service 110 and/or database 115. If the user is associated with the meeting, the user may be an authorized user. If the user is not an organizer or participant, collaboration system 105 may determine whether the identified user has a designated role, status, or permissions enabling access to the meeting information. For example, as previously discussed, collaboration system 105 may be associated with an entity, such as a corporation, and database 115 may further store various roles, statuses, or permissions associated with each employee. Therefore, collaboration system 105 may determine whether the identified user has a designated role, status, or permissions enabling access to the meeting information by comparing an identity of the user to stored roles, statuses, or permissions for the user within database 115. To provide examples, a chief executive officer, a board of directors, or an upper level employee, among other similar positions, may be able to access the meeting information even though they are not a participant of the meeting. If the user has a designated role, status, or permissions, the user may be an authorized user.

Once a determination is made at stage 260, and the determination is to display, one or more portions of the meeting information may be provided for display through dashboard user interface 170 of the shared device at stage 270. In one embodiment, the one or more portions of the meeting information to be displayed may be determined based on a confidentiality level of the meeting and/or a type of information contained within the meeting information (e.g., sensitive information). Additionally, the determination may be based on an authorization basis associated with the user. For example, an organizer may be authorized to access more portions of the meeting information than a participant, and both organizer and participant may be authorized to access more portions than a user having a designated role, status, or permissions enabling access.

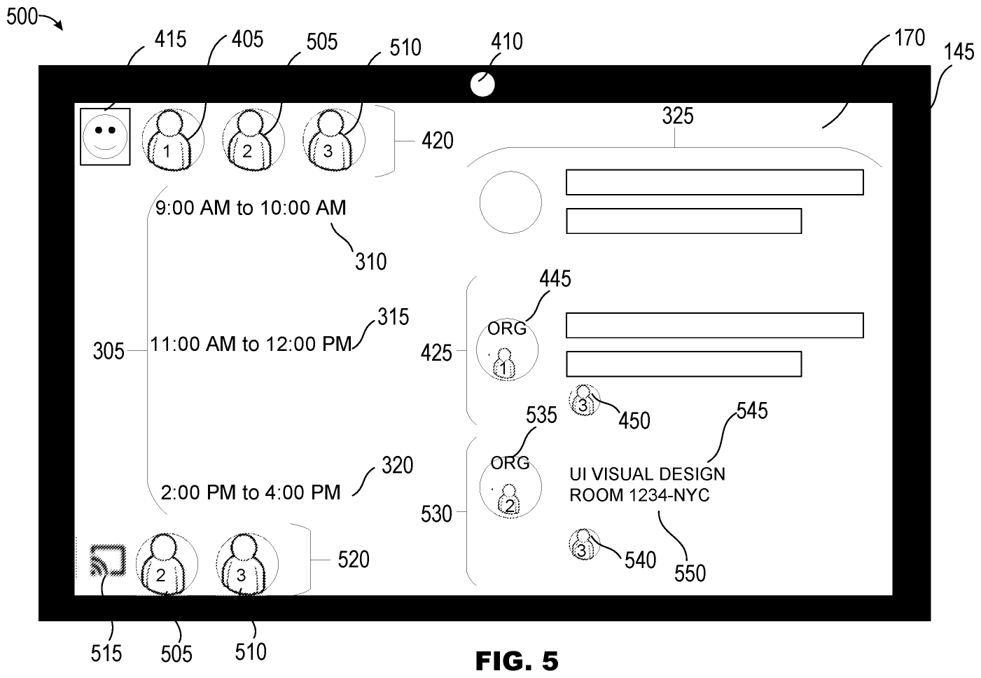

In another embodiment, the one or more portions of the meeting information to be displayed may be determined based on a detected presence and determined identity of one or more other users at local endpoint 130 or remote endpoints 135 of the video conferencing service, as described in detail with respect to FIG. 5. In some examples, user options to join the meeting, edit the meeting, and schedule a new meeting may also be displayed through the dashboard user interface of the shared device. If the determination at stage 260 is not to display, display of the meeting information through dashboard user interface 170 of the shared device may continue to be suppressed, hidden, or otherwise blocked.

Once the portions of meeting information are displayed through the dashboard user interface of the shared device at stage 270, method 200 may then end at stage 280. In further, optional embodiments, the portions of meeting information displayed may be subsequently suppressed, hidden or otherwise blocked from display if a presence of another user is detected at an endpoint, and a determination of the other user's identity reveals the other user is not authorized to access the meeting information.

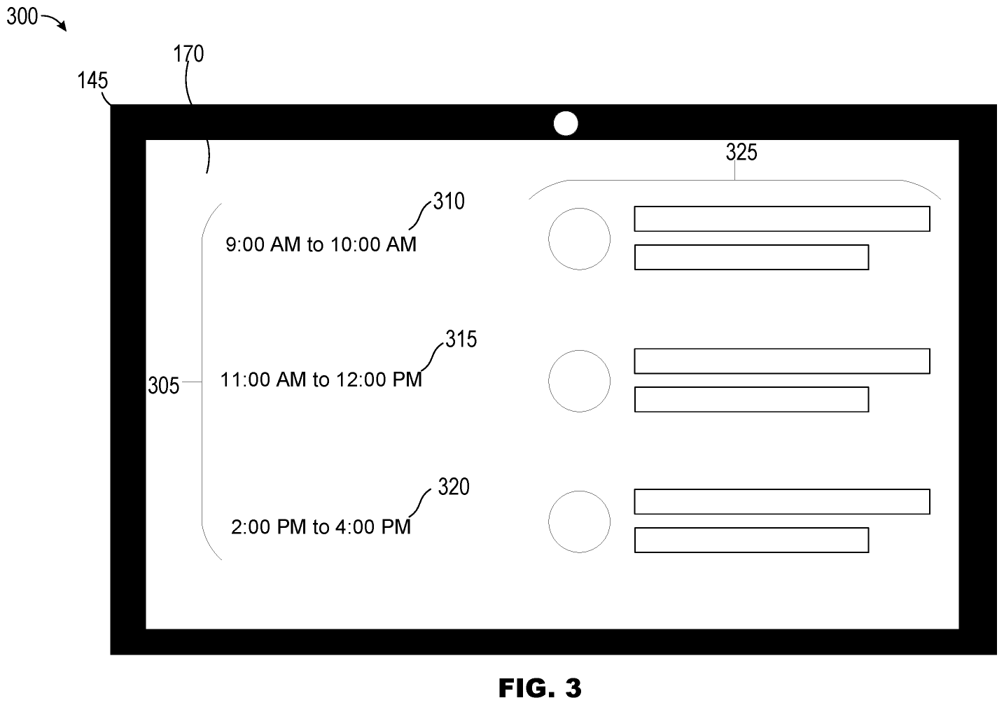

FIG. 2 describes a single meeting associated with conference room 125 for which a schedule and one or portions of meeting information may be displayed. However, in other examples, more than one meeting may be associated with conference room 125. For example, on a particular day, multiple meetings hosted by video conferencing service 120 may be scheduled to be held in conference room 125. Schedules and meeting information for each meeting may be retrieved, and the schedule for each meeting may be displayed through dashboard user interface 170 of shared device as discussed in stages 220 and 230. For example, the schedules of meetings may be displayed in a list as illustrated in FIG. 3. Then, method 200 may proceed to stages 240, 250, 260, 270 and 280 for each meeting.

FIG. 3 is an example configuration 300 of dashboard user interface 170 displayed prior to user detection at one or more endpoints. As illustrated, dashboard user interface 170 is displayed through a shared device accessible by multiple users, such as conferencing device 145 located in conference room 125. In other examples, configuration 300 of dashboard user interface 170 may be displayed through display device 150 described in FIG. 1. In further examples, configuration 300 of dashboard user interface 170 may be displayed through both conferencing device 145 and display device 150 simultaneously.

Prior to detecting a user presence at local endpoint 130 or remote endpoints 135 of video conferencing service 120, dashboard user interface 170 may display a list 305 comprising a schedule for one or more meetings hosted by video conferencing service 120 and for which conference room 125 was reserved over a particular time period. The schedule within list 305 may include a time block for each meeting. For example, list 305 may include a schedule for a first meeting 310 from 9:00 AM to 10:00 AM today, a schedule for a second meeting 315 from 11:00 AM to 12:00 PM today, and a schedule for a third meeting 320 from 2:00 PM to 4:00 PM today in conference room 125. Additionally, an entirety of meeting information associated with each of meeting may be suppressed, hidden, or otherwise blocked from display on dashboard user interface 170, as shown in an area 325 of dashboard user interface 170.

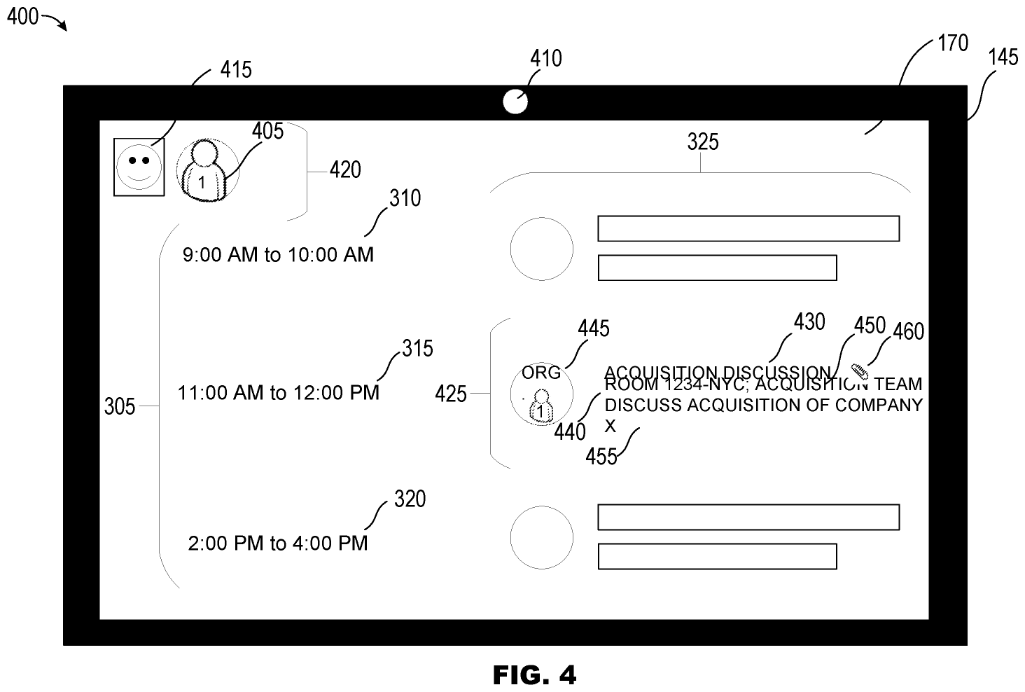

FIG. 4 is an example configuration 400 of dashboard user interface 170 displayed subsequent to a single user detection at local endpoint 130. As illustrated, dashboard user interface 170 may be displayed through a shared device accessible by multiple users, such as conferencing device 145 located in conference room 125. In other examples, configuration 400 of dashboard user interface 170 may be displayed through display device 150 described in FIG. 1. In further examples, configuration 400 of dashboard user interface 170 may be displayed through both conferencing device 145 and display device 150 simultaneously.

A presence of a first user 405 may be detected proximate to local endpoint 130 associated with conference room 125. For example, first user 405 may be the user physically present in conference room 125 and associated with mobile phone 155 described in FIG. 1. In one embodiment, conferencing device 145 may detect the presence of first user 405. For example, conferencing device 145 may include proximity sensors that may detect a presence of first user 405 as he or she physically enters conference room 125 or comes within a particular distance of conferencing device 145. In response to detecting the presence of first user 405, images or video of first user 405 and surrounding conference room 125 may be captured by a camera 410 of conferencing device 145. In other examples, camera 410 may continuously capture images and/or video regardless of user presence.

In another embodiment, display device 150 or one or more other endpoint devices at local endpoint 130, such as mobile phone 155 described in FIG. 1, may detect the presence of first user 405 proximate to local endpoint 130. Similar to conferencing device 145, display device 150 and/or mobile phone 155 may include proximity sensors that detect the presence of first user 405 and may include a camera through which images or video are captured in response to the detection. In a further embodiment, conferencing device 145, display device 150, and mobile phone 155 at local endpoint 130 may detect the presence of first user 405 and capture images or videos simultaneously.

The images or video captured may be provided to facial recognition system 175. Facial recognition system 175 may detect a face in the images or video, quantify features of the face, and then match the features against templates to determine an identity of the user as first user 405. In some embodiments, the templates may be created based on contact information retrieved from collaboration system 105. For example, collaboration system 105 may be associated with an entity, such as a corporation, and contact information retrieved from collaboration system 105 may include employees of the corporation, where first user 405 may be one of the employees.

Upon determining an identity of the user as first user 405, a facial recognition icon 415 may be displayed in dashboard user interface 170 along with one or more identified user icons 420 representing each user whose presence has been detected and identity determined. In some examples, identified user icons 420 may include an image or an avatar of each user. In other examples, identified user icons 420 may include other representative information of each user provided in a textual or graphical format. As illustrated, first user 405 may be the only user whose presence has been detected and identity determined, and an image of first user 405 may be provided among the identified user icons 420.

Additionally, based on the identity of first user 405, collaboration system 105 may determine which, if any, portions of meeting information associated with each meeting in list 305 to display. For example, first user 405 may be an organizer of second meeting 315, and thus an authorized user to access information associated with second meeting 315. Therefore, based on first user 405 being the organizer of second meeting 315 and being detected proximate to local endpoint 130, at least a portion of meeting information 425 may be displayed along with the schedule for second meeting 315 in area 325 of dashboard user interface 170. Meeting information 425 may include a subject 430, a location 440, an organizer 445, one or more participants, a description 455, and/or one or more attachments 460 (e.g., documents, files, etc.) associated with the second meeting 315. In some examples, an icon displaying an image of the organizer 445 and/or images of the participants 450 may be provided.

In other embodiments, first user 405 may be a participant rather than an organizer. While first user 405 may still be an authorized user to access information based on participation in second meeting 315, in some examples, first user 405 may not receive an entirety of the meeting information 425 received by an organizer. For example, attachments 460 may not be displayed to a participant as these may be specific to organizer's presentation. In further embodiments, the organizer and all participants of second meeting 315 may need to be detected proximate to local endpoint 130 or remote endpoints 135 and identified before meeting information 425 is displayed.

In additional embodiments, first user 405 may not be a participant or organizer of second meeting 315. However, first user 405 user may have a designated role, status, or permissions, among other examples, that enable first user 405 to have access to meeting information 425 regardless of their participation, and thus meeting information 425 may be displayed upon identification of first user 405.

Which portions of meeting information 425 are displayed may be based on various factors, such as confidentiality of the meeting, types of information within meeting information 425, a basis of the user's authorization, a location of the shared device, and a presence/identity of other users. For example, second meeting 315 may be a highly confidential meeting involving a discussion of a large corporation acquiring another large corporation. While access to meeting information 425 is highly useful to those participating in second meeting 315, the implications of a potential acquisition would likely warrant prudence in suppressing this information from others at least until the acquisition occurs. Therefore, it would not be desirable to openly display meeting information 425 where anyone could see it.

Currently, because first user 405 is an authorized user and no other users' presence has been detected, an entirety of meeting information 425 may be displayed through dashboard user interface 170 of conferencing device 145 located within conference room 125. However, given the highly confidential nature of second meeting 315, limited portions of meeting information 425 or none at all may be displayed through dashboard user interface 170 on display device 150 because display device 150 is located external to conference room 125 where anyone may openly see the meeting information 425 as they walk by.

In another example, portions of meeting information 425 may initially be displayed on display device 150 as first user 405 is detected and identified upon entering conference room 125. Display of meeting information 425 may then subsequently be suppressed, hidden, or otherwise blocked on display device 150 upon detecting a presence of another user walking past conference room 125, and the identity determination of the other user reveals the user is not authorized to access meeting information 425 (e.g., the other user is not an organizer, not a participant, and does not have a designated role, status, or permissions to access).

Additionally, as described in FIG. 1, endpoint devices of both local endpoint 130 and remote endpoints that are personal to a user (e.g., mobile phone 155, laptop 160, and tablet 165) may be paired with conferencing device 145 causing information displayed through conferencing device 145 to also be viewable on paired endpoint devices. As a result, if presence of another user is detected either proximate to local endpoint 130 or remote endpoints 135 via a paired endpoint device and a determination of the other user's identity reveals that they are not organizers, participants or others having a designated role, status, or permissions enabling access to meeting information 425, limited portions of meeting information 425 or none at all may be displayed through dashboard user interface 170 of conferencing device 145, as shown in FIG. 5 below.

In further embodiments, voice interactions may be implemented. For example, after identifying first user 405 via facial recognition, upcoming meetings for which the first user is an organizer, participant, or otherwise designated to have access to may be audibly presented through one or more of conferencing device 145, display device 150, and/or other endpoint device, such as mobile phone 155. An example voice interaction may be as follows: “Welcome First User. Here are your upcoming meetings in 1234-NYC, Acquisition Discussion between 11 and 12 today.”

In some examples, based on the identification of first user 405 via facial recognition, a speech recognition language may be pre-selected for use in the voice interactions. Additionally, voice interactions may be switched from a speaker independent to a more accurate speaker dependent mode, once first user 405 has been identified.

Although the scenario described above with respect to FIG. 4 determined the identity of first user 405 by performing facial recognition, proximity technology may be employed instead of or in addition to facial recognition to determine the identity of first user 405 physically present in conference room 125. Details for determining the identity of first user 405 by employing proximity technology are described above in FIG. 1 and FIG. 2.

FIG. 5 is an example configuration 500 of dashboard user interface 170 displayed subsequent to multiple user detection at local endpoint 130 and one or more remote endpoints 135. As illustrated, dashboard user interface 170 may be displayed through a shared device accessible by multiple users, such as conferencing device 145 located in conference room 125. In other examples, configuration 500 of dashboard user interface 170 may be displayed through display device 150 described in FIG. 1. In further examples, configuration 500 of dashboard user interface 170 may be displayed through both conferencing device 145 and display device 150 simultaneously.

Additionally, endpoint devices of both local endpoint 130 and remote endpoints that are personal to a user (e.g., mobile phone 155, laptop 160, and tablet 165) may be paired with conferencing device 145. As a result, information displayed through dashboard user interface 170 of conferencing device 145 may also be viewable on paired endpoint device.

As previously discussed with respect to FIG. 4, first user 405 (e.g., the user physically present in conference room 125 and associated with mobile phone 155 described in FIG. 1) may be detected proximate to local endpoint 130 and images or video of first user 405 may be captured by cameras of conferencing device 145, display device 150 and/or other endpoint devices located at local endpoint 130. Facial recognition system 175 may receive the images or video and determine an identity of first user 405. As a result, facial recognition icon 415 may be displayed in dashboard user interface 170 along with an icon among identified user icons 420 representing first user 405.

Subsequently, one or more additional users may be detected proximate to remote endpoints 135. For example, an endpoint device at each remote endpoint, such as laptop 160 and tablet 165 at remote endpoints 135, may detect the additional users' presence proximate to respective remote endpoints 135. The endpoint devices may include proximity sensors that detect the additional users' presence and capture images or video through a camera of each respective endpoint device in response to the detection. The images or video captured by the endpoint devices may be provided to a facial recognition system 175. Facial recognition system 175 may detect a face in the images or video, quantify features of the face, and then match the features against stored templates in a database to identify the additional users.

Upon the presence detection and identity determination of the additional users associated with remote endpoints, additional icons may be included among identified user icons 420 to represent the additional users who were identified. For example, as illustrated in FIG. 5, second user 505 and third user 510 may be identified, and an image or avatar of second user 505 and third user 510 may be provided along with first user 405 among identified user icons 420. Second user 505 may be the user connecting to video conferencing service 120 from the home office via laptop 160, and third user 510 may be the user connecting to video conferencing service 120 from the airport via tablet 165, as described in FIG. 1.

In some embodiments, to designate users connecting to video conferencing service 120 via remote endpoints 135 (e.g., users associated with endpoint devices of remote endpoints 135 paired with conferencing device 145), a pairing icon 515 may be displayed through dashboard user interface 170 along with remote user icons 520 representing users who are connecting remotely, such as second user 505 and third user 510. In some examples, remote user icons 520 may include an image of each remote user. In other examples, remote user icons 520 may include other representative information for each remote user in a textual or graphical format.

Additionally, based on the determined identity of first user 405, second user 505, and third user 510, collaboration system 105 may determine which portions of meeting information associated with each of the meetings in list 305 to display. For example, first user 405 may be an organizer of second meeting 315 and third user 510 may be a participant of second meeting 315. Therefore, both first user 405 and third user 510 may be authorized to access meeting information 425 based on their involvement in second meeting 315, and at least a portion of meeting information 425 may be displayed in association with second meeting 315 in area 325 of dashboard user interface 170. However, unlike the variety of information displayed in the scenario described in FIG. 4, meeting information 425 displayed in FIG. 5 may be limited to icons displaying an image of organizer 445 (e.g., first user 405) and images of participants 450 (e.g., third user 510).

In one embodiment, meeting information 425 displayed through dashboard user interface 170 may be limited due to the confidential nature of second meeting 315 in addition to the detected presence and determined identity of second user 505 (e.g., an unauthorized user who is not participating in second meeting 315 or otherwise designated to have access). In another embodiment, meeting information 425 may be limited because not all participants of second meeting 315 have been detected and identified.

To provide another example, second user 505 may be an organizer of third meeting 320 and third user may be a participant of third meeting 320. Therefore, both second user 505 and third user 510 may be authorized to access meeting information 530 based on their involvement in third meeting 320, and at least a portion of meeting information 530 may be displayed in association with third meeting 320 in area 325 of dashboard user interface 170. Third meeting 320 may not be as confidential in nature as second meeting 315, and thus more portions of meeting information 530 may be displayed through dashboard user interface 170. For example, in addition to an organizer 535 (e.g., second user 505) and one or more participants 540 (e.g., third user 510), a subject 545 and location 550 of third meeting 320 may also be displayed.

Although portions of meeting information 425, 530 displayed through dashboard user interface 170 of conferencing device 145 and/or display device 150 (e.g., shared devices) may be limited, one or more additional portions or an entirety of meeting information 425, 530 may be provided for display through endpoint devices that are personal devices associated with authorized users. For example, first user 405, as organizer 445 of second meeting 315, may receive an entirety of meeting information 425 through mobile phone 155. Second user 505, as organizer of third meeting 320, may receive an entirety of meeting information 530 through laptop 160. Third user 510, as a participant of both second meeting 315 and third meeting 320, may receive at least one or more additional portions of meeting information 425 and meeting information 530 through tablet 165.

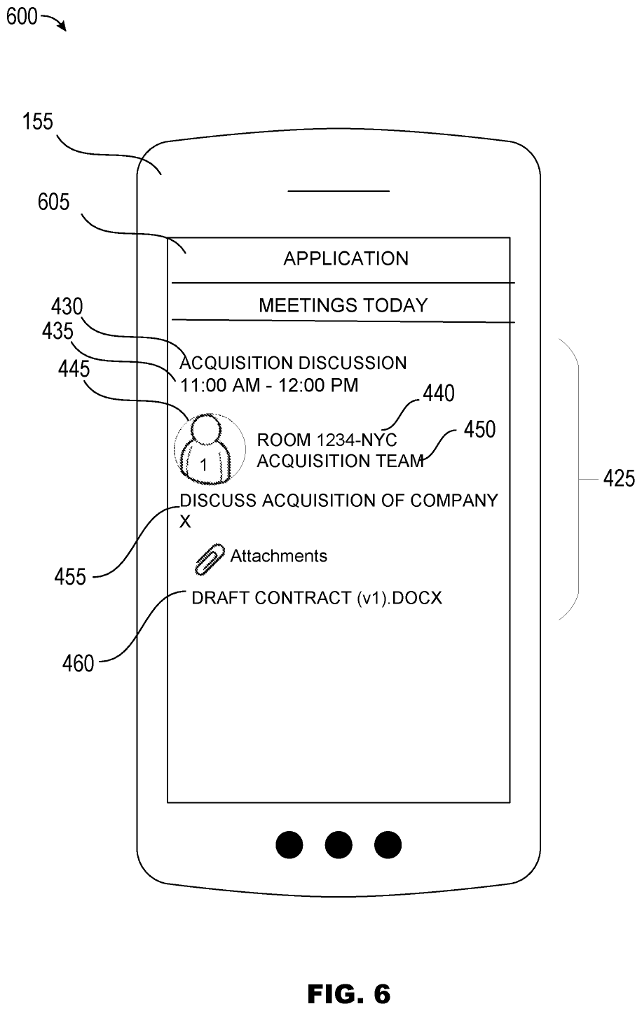

Meeting information 425,530 may be provided for display through an application associated with collaboration system 105. The application may be a thin version (e.g., a web browser) or a thick version of the application (e.g., a locally installed application) running on mobile phone 155, laptop 160, and tablet 165, respectively. In some examples, meeting information 425, 530 may be provided as a notification. Additional details are provided with respect to FIGS. 6, 7, and 8.

FIG. 6 is an example notification 600 displayed on a personal device of an authorized user at local endpoint 130. Mobile phone 155 may be an endpoint device of local endpoint 130 located within or proximate to conference room 125. For example, mobile phone 155 may be a personal device of a user physically present in conference room 125, such as first user 405. As organizer 445 of second meeting 315, the first user 405 may be deemed an authorized user and may have access to an entirety of meeting information 425 through mobile phone 155.

In some embodiments, meeting information 425 may be displayed to first user 405 through an application 605 associated with collaboration system 105. Application 605 may be a thin version (e.g., a web browser) or a thick version (e.g., a locally installed application) of application 605 running on mobile phone 155. In some embodiments, application 605 may be a calendaring application associated with calendaring service 110 of collaboration system 105. In other embodiments, application 605 may be a video conferencing application associated with video conferencing service 120. In further embodiments, application 605 may be a single application associated with collaboration system 105 that combines features and services of both calendaring service 110 and video conferencing service 120.

Here, as illustrated, application 605 may display meetings associated with first user 405 for today. In other examples, meetings may be displayed for the week, the month, or a pre-selected date range. Meeting information 425 displayed through the application 605 may include subject 430, time 435, location 440, organizer 445, participants 450, description 455, and attachments 460 associated with second meeting 315.

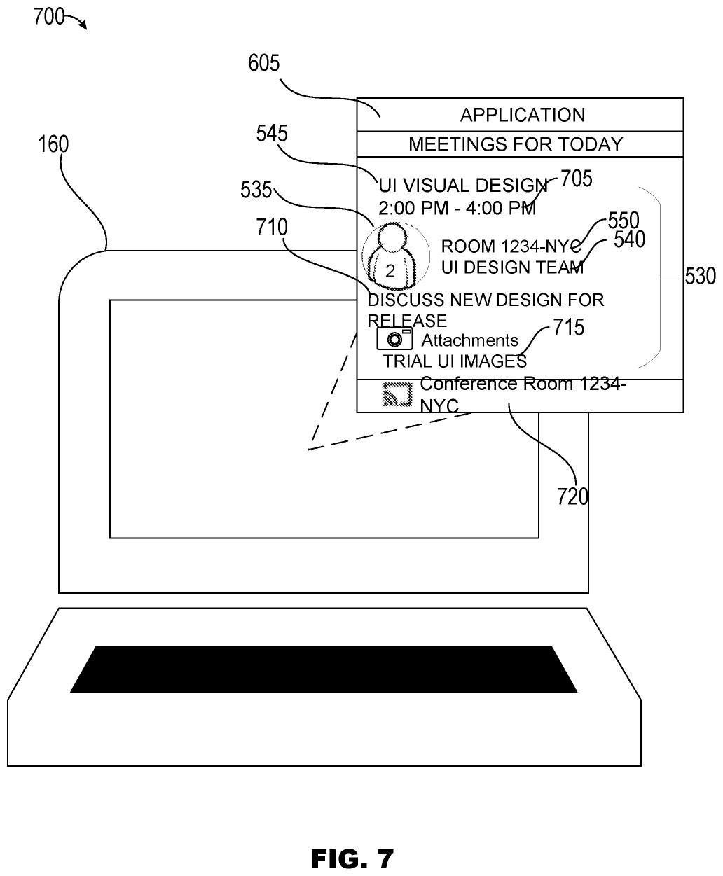

FIG. 7 is an example notification 700 displayed on a personal device of an authorized user at remote endpoint 135. Laptop 160 may be an endpoint device of one of remote endpoints 135 that is located geographically separate from conference room 125. For example, laptop 160 may a personal device located in a home office of second user 505. As organizer of third meeting 320, second user 505 may be deemed an authorized user and may have access to an entirety of meeting information 530 through laptop 160. Meeting information 530 may be displayed to second user 505 through application 605 associated with collaboration system 105, as discussed in greater detail with respect to FIG. 6.

Here, as illustrated, application 605 may display meetings associated with second user 505 for today. In addition to organizer 535, participants 540, subject 545, and location 550 of third meeting 320 displayed through dashboard user interface 170 in FIG. 5, meeting information 530 displayed through application 605 may also include a time 705, a description 710, and attachments 715 associated with third meeting 320. Additionally, application 605 may display a pairing indication 720 that notifies second user 505 that laptop 160 is paired with a shared device at local endpoint 130, such as conferencing device 145 in conference room 125.

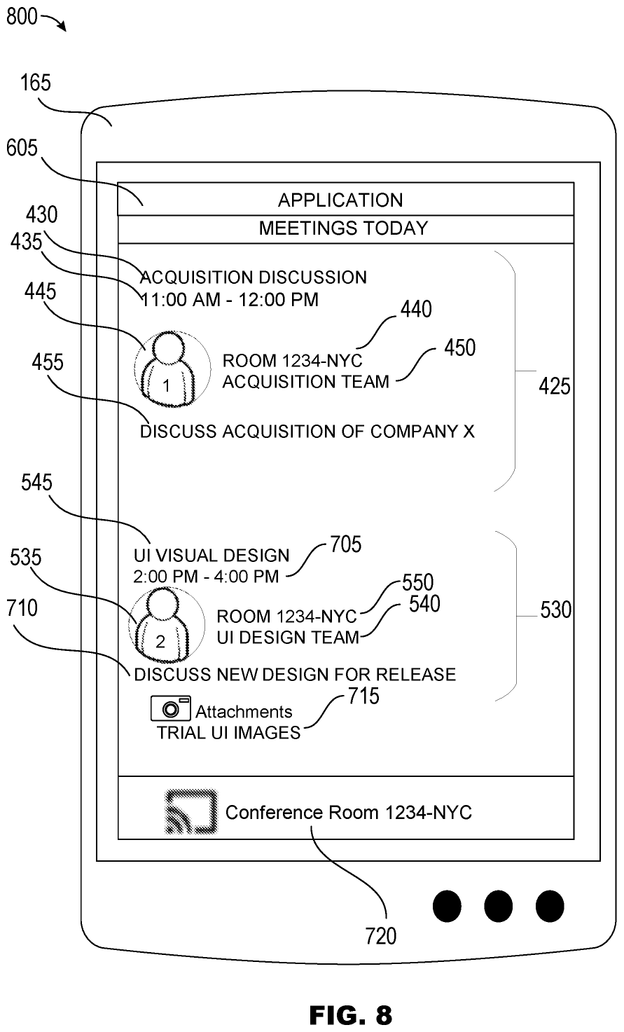

FIG. 8 is another example notification 800 displayed on a personal device of an authorized user at remote endpoint 135. Tablet 165 may be an endpoint device of one of remote endpoints 135 that is located geographically separate from conference room 125. For example, tablet 165 may be located in an airport as third user 510 is on travel. As a participant of second meeting 315 and third meeting 320, third user 510 may be deemed an authorized user and may have access to at least one or more portions of meeting information 425 and meeting information 530 through tablet 165. Meeting information 425, 530 may be displayed to third user 510 through application 605 associated with collaboration system 105, as discussed in greater detail with respect to FIG. 6.

Here, as illustrated, application 605 may display meetings associated with third user 510 for today. In some embodiments, a basis of authorization, among other factors, may affect portions of information received for display. For example, meeting information 425 displayed through application 605 may include subject 430, time 435, location 440, organizer 445, participants 450, and description 455 of second meeting 315. However, because third user 510 is a participant rather than an organizer, and given the highly confidential nature of second meeting 315, attachments 460 associated with second meeting 315 that were provided to first user 405 in notification 600 may not be provided to third user 510 in notification 800.

However, in other embodiments, an authorization basis of participant versus organizer may not affect portions of information received. For example, meeting information 530 displayed through application 605 may include subject 545, time 705, location 550, organizer 535, participants 540, description 710, and attachments 715 associated with third meeting 320. Thus, third user 510 receives an entirety of meeting information 530 in notification 800, similar to second user 505 in notification 700

Additionally, application 605 may display pairing indication 720 that notifies third user 510 that tablet 165 is paired with a shared device at local endpoint 130, such as conferencing device 145 in conference room 125.

The example notifications provided above in FIGS. 6, 7, and 8 are for illustrative purposes only, and are not intended to be limiting. Additional or alternative textual schemes, graphical schemes, audio schemes, animation schemes, coloring schemes, highlighting schemes, and/or shading schemes may be utilized to enhance the display of the notifications.

According to some example embodiments, a secure dashboard user interface for a multi-endpoint meeting may be provided. A schedule and meeting information for a meeting hosted by a video conferencing service may be retrieved, and the schedule may be provided for display through a dashboard user interface of a shared device located within or proximate to a conference room reserved for the meeting. A presence of a user may be detected at an endpoint of the video conferencing service. An identity of the user may be determined, and based on the identity of the user, a determination of whether to display the meeting information may be made. In response to a determination to display, one or more portions of the meeting information may be provided for display through the dashboard user interface of the shared device.

In other example embodiments, determining whether to display the meeting information includes a determination of whether the user is authorized to access the meeting information. An authorized user may be an organizer of the meeting, a participant of the meeting, or has been designated a role, status or permissions that allow the user access to the meeting information. The identity of the user may be compared to the meeting information retrieved to determine whether the user is an organizer of the meeting or a participant of the meeting. The identity of the user may be compared to roles, statuses, or permissions stored within a database to determine whether the user has a designated role, status, or permissions that allow the user access to the meeting information. Determining the one or more portions of the meeting information to be provided for display may be based on a confidentiality level associated with the meeting, a type of information contained within the meeting information, an authorization basis of the user, a location of the shared device, and/or a detected presence and determined identity of one or more other users at an endpoint of the video conferencing service.

In further example embodiments, the identity of the user may be determined by performing facial recognition and/or employing proximity technology. Prior to detecting the presence of the user and determining the identity of the user, a display of the meeting information through the dashboard user interface of the shared device may be suppressed. The display of the meeting information through the dashboard user interface of the shared device may continue to be suppressed in response to a determination to not display. Providing the schedule of the meeting information for display may include providing a time block for the meeting. Providing the one or more portions of the meeting information for display may include providing a subject, a location, a description, an organizer, one or more participants, and/or one or more documents associated with the meeting.

According to other example embodiments, a system may include a memory storage being disposed in a collaboration system, and a processing unit coupled to the memory storage and being disposed in the collaboration system. The processing unit may be operative to retrieve a schedule and meeting information for a meeting hosted by a video conferencing service; and provide the schedule for display through a dashboard user interface of a shared device located within or proximate to a conference room reserved for the meeting. The processing unit may also be operative to detect a presence of a user at an endpoint of the video conferencing service, determine an identity of the user, and, based on the identity of the user, determine whether to display the meeting information. The processing unit may further be operative to provide one or more portions of the meeting information for display through the dashboard user interface of the shared device in response to a determination to display.

According to further example embodiments, a computer-readable storage medium may include instructions stored thereon, that when executed by a collaboration system, provide a secure dashboard user interface for a multi-endpoint meeting. The instructions may include retrieving a schedule and meeting information for a meeting hosted by a video conferencing service, and providing the schedule for display through a dashboard user interface of a shared device located within or proximate to a conference room reserved for the meeting. The instructions may further include detecting a presence of a user at an endpoint of the video conferencing service; determining an identity of the user; and, based on the identity of the user, determining whether to display the meeting information. The instructions further include providing one or more portions of the meeting information for display through the dashboard user interface of the shared device in response to a determination to display.

FIG. 9 shows computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for securing a dashboard user interface for a multi-endpoint meeting, including for example, any one or more of the stages from method 200 described above with respect to FIG. 2. Computing device 900, for example, may provide an operating environment for elements of operating environment 100 including, but not limited to, collaboration system 105, calendaring service 110, database 115, video conferencing service 120, local endpoint 130, remote endpoint 135, network 140, conferencing device 145, display device 150, other endpoint devices 155, 160, 165, dashboard user interface 170, and facial recognition system 175). Elements of operating environment 100 (e.g., collaboration system 105, calendaring service 110, database 115, video conferencing service 120, local endpoint 130, remote endpoint 135, network 140, conferencing device 145, display device 150, other endpoint devices 155, 160, 165, dashboard user interface 170, and facial recognition system 175) may operate in other environments and are not limited to computing device 900.

Computing device 900 may be implemented using a Wireless Fidelity (Wi-Fi) access point, a cellular base station, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 1 may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 900 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
retrieving a schedule and meeting information for a meeting hosted by a video conferencing service;
providing the schedule for display through a dashboard user interface of a shared device located within or proximate to a conference room reserved for the meeting;
detecting a presence of a user at an endpoint of the video conferencing service;
determining an identity of the user, wherein determining the identity of the user comprises:
receiving one or more of an image or video of the user captured by a camera of an endpoint device;
detecting a face in the image or the video;
quantifying features of the detected face; and
matching the quantified features to a template from a plurality of templates to determine the identity of the user, wherein the plurality of templates are created based on contact information retrieved from a database of the collaboration system;
based on the identity of the user, determining whether to display the meeting information; and
in response to a determination to display, providing one or more portions of the meeting information for display through the dashboard user interface of the shared device.

2. The method of claim 1, wherein determining whether to display the meeting information comprises:
determining whether the user is authorized to access the meeting information, wherein an authorized user is one or more of an organizer of the meeting, a participant of the meeting, or has been designated a role, status or permissions that allow the user access to the meeting information.

3. The method of claim 2, further comprising:
comparing the identity of the user to the meeting information retrieved to determine whether the user is the organizer of the meeting or the participant of the meeting; and
comparing the identity of the user to roles, statuses, or permissions stored within a database to determine whether the user has been designated the role, status, or permissions that allow the user access to the meeting information.

4. The method of claim 1, further comprising:
determining the one or more portions of the meeting information to be provided for display based on one or more of a confidentiality level associated with the meeting, a type of information contained within the meeting information, an authorization basis of the user, a location of the shared device, and a detected presence and determined identity of one or more other users at an endpoint of the video conferencing service.

5. The method of claim 1, wherein determining the identity of the user comprises one or more of:
performing facial recognition to determine the identity of the user; and
employing proximity technology to determine the identity of the user.

6. The method of claim 1, further comprising:
prior to detecting the presence of the user and determining the identity of the user, suppressing a display of the meeting information through the dashboard user interface of the shared device.

7. The method of claim 6, further comprising:
in response to a determination to not display, continuing to suppress the display of the meeting information through the dashboard user interface of the shared device.

8. The method of claim 1, wherein providing the schedule of the meeting information for display comprises:
providing a time block for the meeting.

9. The method of claim 1, wherein providing the one or more portions of the meeting information for display comprises:
providing one or more of a subject, a location, a description, an organizer, one or more participants, and one or more documents associated with the meeting.

10. A system comprising:
a memory storage being disposed in a collaboration system; and
a processing unit coupled to the memory storage and being disposed in the collaboration system, wherein the processing unit is operative to:
retrieve a schedule and meeting information for a meeting hosted by a video conferencing service;
provide the schedule for display through a dashboard user interface of a shared device located within or proximate to a conference room reserved for the meeting;
detect a presence of a user at an endpoint of the video conferencing service;
determine an identity of the user, wherein the processing unit being operative to determine the identity of the user comprises the processing unit being operative to:
receive one or more of an image or video of the user captured by a camera of an endpoint device,
detect a face in the image or the video,
quantify features of the detected face, and
match the quantified features to a template from a plurality of templates to determine the identity of the user, wherein the plurality of templates are created based on contact information retrieved from a database of the collaboration system;
based on the identity of the user, determine whether to display the meeting information; and
in response to a determination to display, provide one or more portions of the meeting information for display through the dashboard user interface of the shared device.

11. The system of claim 10, wherein the identity of the user is determined by performing facial recognition and employing proximity technology.

12. The system of claim 10, further comprising a voice interaction system communicatively coupled to the collaboration system, the voice interaction system operative to generate audio output comprising the one or more portions of the meeting information for aural presentation to the user via an audio output device of the shared device.

13. The system of claim 12, wherein a language for the aural presentation is automatically selected based on the identity of the user.

14. The system of claim 12, wherein the voice interaction system is further operative to automatically switch from a user independent mode to a user dependent mode based on the identity of the user.

15. The system of claim 10, wherein the processing unit is further operative to:
based on the identity of the user, provide the meeting information for display through a user interface of an application associated with the collaboration system that is executing on a personal device of the user.

16. The system of claim 10, wherein the shared device is one or more of a conferencing device located in the conference room and a display device located external but proximate to the conference room.

17. The system of claim 10, wherein the endpoint of the video conferencing service is a local endpoint associated with the conference room or a remote endpoint.

18. A computer-readable storage medium having instructions stored thereon comprising:
retrieving a schedule and meeting information for a meeting hosted by a video conferencing service;
providing the schedule for display through a dashboard user interface of a shared device located within or proximate to a conference room reserved for the meeting;
detecting a presence of a user at an endpoint of the video conferencing service;
determining an identity of the user, wherein determining the identity of the user comprises:
receiving one or more of an image or video of the user captured by a camera of an endpoint device;
detecting a face in the image or the video;
quantifying features of the detected face; and
matching the quantified features to a template from a plurality of templates to determine the identity of the user, wherein the plurality of templates are created based on contact information retrieved from a database of the collaboration system;
based on the identity of the user, determining whether to display the meeting information; and
in response to a determination to display, providing one or more portions of the meeting information for display through the dashboard user interface of the shared device.

19. The computer-readable storage medium of claim 18, further comprising:
based on the identity of the user, providing options to one or more of join the meeting, edit the meeting, and schedule a new meeting through the dashboard user interface of the shared device.

20. The computer-readable storage medium of claim 18, further comprising:
subsequent to the display of the one or more portions of the meeting information through the dashboard user interface of the shared device, suppressing the display of the one or more portions of the meeting information in response to a detected presence and determined identity of one or more other users at an endpoint of the video conferencing service that are not authorized to access the meeting information.
